(19) United States
(12) Patent Application Publication
(10) Pub. No.: US 2012/0179972 A1
(43) Pub. Date: Jul. 12, 2012

(54) ADVISOR-ASSISTANT USING SEMANTIC ANALYSIS OF COMMUNITY EXCHANGES

(76) Inventors: Hakim Hacid, Nozay (FR); Johann Stan, Bagneux (FR); Maria Coralia Laura Maag, Nozay (FR); Ryan Skraba, Nozay (FR)

(21) Appl. No.: 13/380,669

(22) PCT Filed: May 12, 2010
(86) PCT No.: PCT/EP10/56590

§ 371 Date: Mar. 29, 2012

(30) Foreign Application Priority Data
Jun. 26, 2009 (FR) 0903121

(51) Int. Cl. G06F 3/01

(52) U.S. Cl. 715/738

(57) ABSTRACT

A method for enriching the content of a page (2) that is placed online within a communication platform and may be consulted with the help of a browser (1), said user being registered with at least one social network (12, 13, 14), which method comprises:
extracting relevant terms from the page (2) being explored by the user;
semantically synthesizing the content of a plurality of social networks that comprises at least one social network with which the user is registered;
retrieving information concerning the relevant terms extracted from the semantic synthesis of the content of the social networks with which the user is registered;
displaying the retrieved information to the user.

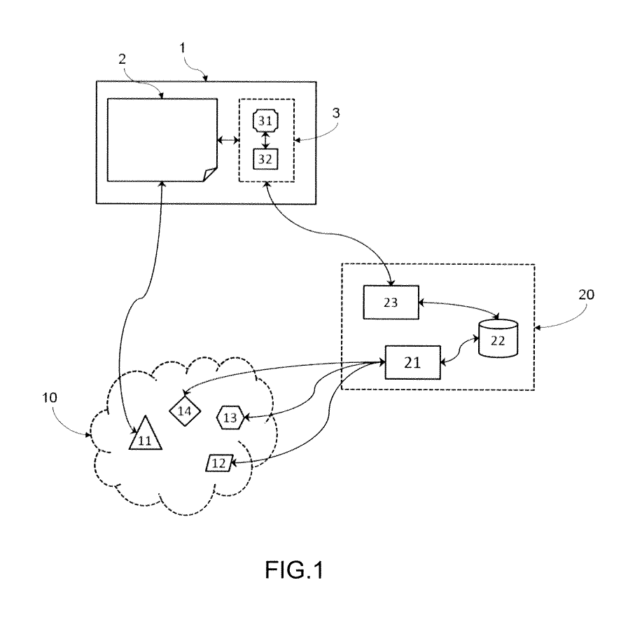

The present invention pertains to the field of user interactions within a communication platform, and more particularly to the enrichment of user browsing based on social browsing.

The term “communication platform” hereinafter refers to any communication system that supports user interactions via requests sent from terminals connected to that platform. As examples, the following may be cited:
a Web platform hosting a hypertext system that runs on a network of IP terminals and makes possible to consult content placed online within the sites, via requests based on access protocols such as HTTP. HTTPS or FTP, for example;
a WAP (Wireless Application Protocol) platform that enables access to the content placed online from mobile communication terminals with the help of signaling protocols such as SIP (Session Initiation Protocol) for example;
a video-on-demand platform supporting content accessible with the help of access or signaling protocols;
an intranet/extranet platform of a certain establishment (a company, a ministry, or a school, for example.

For example, the term “user browsing” is used hereinafter to refer to any user action with a communication platform with the help of query or signaling requests. A user interaction comprises, for example, searching for/consulting information on the Web, exploring a video-on-demand platform, or exploring a WAP page via a browser appropriate to the communication platform.

Here, “social browsing” or “community browsing” refers to any user interaction carried out within virtual communities. A virtual community donates, within a network, a group of users who generally share an interest, subject, or passion. As examples, one may cite virtual communities of online social networks (www.facebook.com or http://m.facebook.com, www.twitter.com, vvww.linkedin.com, www.voutube.com), discussion forums (www.voyaoeforum.com, http://forum.doctissimo.fr), blogs, online discussion groups (http://groups.google.fr) or question/answer services (http.//answers.yahoo.com).

Social browsing, whether with or without access restrictions, enables the user to interact with other users who have similar centers of interest that may cover any topic. An example interaction consists of exploring, publishing, editing, or loading text content (an article, a comment) graphical content (a photo, drawing, or diagram), or audio or visual content (videos). It is therefore frequent that the same topic is treated differently by users, such that sharing the content of these user interactions makes available a wealth of knowledge about a single subject, which is difficult to find outside of these networks.

In parallel, another dominant practice o users is user browsing. Communications platforms constitute a dynamic source of information which is nearly infinite, universal, heterogenous, and often free of charge. The purpose of this browsing maybe to search for information about, for example, a film, a vacation destination, a book, or a hotel. To that end, there are browsing and search features such as search engines, portals, and tools supported by Web 2.0 such as Web page tagging or event scoring, which enable a user to benefit from the experience of other users.

However, the effectiveness of such browsing remains limited, and does not necessarily fulfill the user's expectations for the following reasons:
user browsing is carried out based on a very generic model, whereas a certain user's level of satisfaction depends on his or her centers of interest, knowledge, skills, current situation, profile, or more generally speaking, his or her social context;
user browsing deals with but makes no distinction between the large quantities of data available on the communication platforms, including social networks that cover centers of interest opposite those of the user. Therefore, as long as the user does not have a source of support that he or she can trust, he or she will not, from his or her own viewpoint, have any guarantee that the information is exhaustive. It is thereby difficult for a user to obtain information that seems complete to him or her within a reasonable time;
user browsing is independent of social browsing, thereby constituting two independent information spaces. The user's great difficulty lies in going from a supposed available knowledge potential to knowledge that is only accurate after several resources have successively been consulted. Consequently, the user is always required to combine, and then synthesize by his- or herself, the explored information from these two information spaces.

The solution known as SocialBrowser system (Jennifer G. et al., “SocialBrowsing: Integrating Social Networks and Web Browsing”, In Proceedings ACM CHI 2007), introduced as an extension to the Firefox® browser, makes it possible to enrich user browsing within the Web platform with the help of social context. It offers different services configured by keywords, which the complementary information will deal with. The SocialBrowser extension proceeds, in a manner that is transparent to the user, as follows:
browsing the content of the Web page being explored by the use n order to identify therein keywords recorded in an expandable database;
importing information (opinions, reviews) dealing with the identified keywords from different predefined services (such as social networks and review sites);
highlighting the key words that match the complementary information; and
when the mouse cursor is moved over a highlighted element, displaying the retrieved raw information that matches it in an infobubble.

The document WO 20080005282 proposes a method to be used with a Web browser to update the content of a webpage with the help of social content.

It has been observed that known systems and methods are imperfect, particularly due to the absence of
advanced interpretation of the content being explored for the purpose of consistent and relevant enrichment from the user's social networks;
advanced processing of the social content to be displayed for the purpose of an expressive and helpful enrichment of the user browsing;
independent appropriation (customization) of the enrichment method, i.e. automatically adapting the content of the enrichment and the user's social context;
assisted user browsing with the help of social content related to the user's social context;
assisted user browsing that gives priority to interactions and human recommendations that come from the user's social browsing;
interactive enrichment of the user browsing based on the social browsing.

One object of the present invention is to automatically and in a customized manner enrich user browsing based on community experience.

Another object of the present invention is to pool the experiences of the so networks' members.

Another object of the present invention is to i prove the quality of service provided by a browser to an identified user,

Another object of the present invention is to customize the user browsing, or in other words, to adapt the user browsing to the user's social context.

Another object of the present invention is to propose a tool that makes it possible to capitalize on the personal experiences contained within the social networks.

Another object of he present invention is to automatically detect a user's browsing behavior.

Another object of the present invention is to interpret and synthesize the identified users' opinions.

Another object of the present invention is to collaboratively use the identified users' opinions within a social network.

Another object of the present invention is to enrich a user's user browsing with the help of information drawn from his or her virtual communities.

Another object of the present invention is to complete a piece of content being explored by user with the help of information depending on his or her social context.

One object of the present invention is to enable interactive enrichment of content being explored by a user.

Another object of the present invention is to improve the user's effectiveness and decision-making when browsing within the communication platform.

Another object of the present invention is to improve, in a customized manner, the interactions between a user and a system for searching for and accessing information.

For this purpose, the invention proposes, according to a first aspect, a method for enriching the content of the page placed online within the communication platform that may be viewed by a user with the help of a browser, said user being registered with at least one social network, which method comprises the following steps:
extracting relevant terms from the page being explored by the user;
semantically synthesizing the content of a plurality of social networks that comprises at least one social network with which the user is registered;
retrieving information about the relevant terms extracted from the semantic synthesis of the content of the social networks with which the user is registered;
displaying the retrieved information to the user.

The invention, according to a second aspect, proposes a device for assisting in the browsing of a user registered with at least one social network and exploring a page placed online within a communications platform that may also be consulted with the help IS of a browser, which assistance device or assistant comprises:
an extension to the browser;
a central semantic unit capitalizing on the content of a plurality of social networks comprising at least one social network with which the user is registered.

According to a third aspect, the invention proposes a computer program product implemented on a memory medium, which may be implemented within an information processing unit, and comprises instructions for incrementing the method summarized above.

Other characteristics and advantages of the invention will become more readily and completely apparent upon reading the description below of one preferred implementation of the method and embodiment of the system, which is given with reference to the attached drawing, in which a diagram illustrates one embodiment of a user browsing assistant, according to the invention, while showing the relationships between its different modules.

In the present description of the method and system for enriching user browsing within a communication platform, the starting assumption is that a user has a terminal (for example, a computer, a PDA or personal digital assistant, or a television set) connected to a network 10, most commonly the Internet, and that this terminal is equipped with a browser 1. The browser 1 is FireFox®, Fennec®, Opera®, Opera Mobile®, or any other explorer that makes it possible to consult a site placed online on the network 10.

During user browsing, the user browses page 2 of a site 11 on the network 10. Page 2 designates any resource that may be consulted by a visitor with the help of the browser 1. The site 11 may be, for example,
a “showcase” website, which presents a company, a school, an association, or a person, for example;
a merchant site (e-commerce), showing off a service or product; or
a promotional site centered around an event, the news, or more generally speaking, a piece of information.

While browsing, the user benefits from the experiences of his or her social networks' members, thanks to the user browsing assistant, which comprises two functional modules, specifically
an extension 3 to the browser 1, installed on the user end; and
a central semantic unit 20, preferentially located on the network end 10.

The extension 3 to the browser 1 makes it possible
to extract the relevant terms from page 2 being explored;
to retrieve from the central semantic unit 20 information regarding the identified relevant terms, the retrieved information being dependent on the user's social context; and
to present the retrieved information to the user.

To do so, the extension 3 comprises two elements:
means of extracting 32 relevant terms from the page 2 being explored by the user; and
a control agent 31.

The extension 3 to the browser 1 first probes the user's social context data. This information may be obtained, for example, when the extension 3 is installed. In this situation, the user may
enter or select from a predefined list the virtual communities with which he is registered (forums, blogs, discussion groups, question/answer services, social networks and collaborative remote work platforms, for example); and potentially
providing the information needed to access the virtual communities to which he or she is registered and which require authentication (identifier, password, proxy, session, or port, for example).

This social context data may be periodically collected when the browser 1 is opened (weekly, monthly, or annually, for example).

As a variant or in combination, the control agent 31 marks the user's social context data in a dynamic manner:
by examining the browser(s) available to the user (browsing history, favorites, bookmarks, shortcuts, and saved login/password, for example); and/or
by controlling the browsing event (for example, clicking on a hyperlink, authentication page, or changing to a new URL). By way of example, when the user browses a forum or has just logged in to a Web page, the control agent 31 offers to save the current social context.

The user's social context data, identified with the help of the control agent 31, enables a detailed description of the user's social context by finding, for example, the groups of a social network of which the user is a member (for example, the user's groups within the social network Facebook®) or the number of posts made by the user within a social network.

With the understanding that a better description of the user's social context increases the utility of the enrichment provided to the content of the page 2 being explored by the user, additional descriptive parameters that highlight the importance accorded by the user to his or her different social networks may be collected. The control agent 31 improves the knowledge of the user's social context by controlling the behavior of his or her social browsing such as
the average time spent on a social network;
the frequency that a social network is visited;
the number of interactions (posting, searching) performed on a o al network;
the size of the list of contacts within a social network;
the frequency that the social network is updated;
the details of the members of the community (age, sex, category: family, friend, colleague, or classmate, for example);
the format of the published content, which is strictly explored by the user (video, audio, photo, text);
the language of the content frequently explored by the user;
the social browsing paths most frequently taken within a social network.

These statistics make it possible to temporarily give priority to one social network over another from among the user's social networks, and consequently to establish an order of preference for the social networks, depending on the user. The result is a better description of the user's social context, making it possible to better adapt and increase the usefulness of the enrichment content to be provided based on these social networks.

In order to follow the variation over time of the details of the user's social context (the user edits his or her contacts list or joins/leaves a group within a social network, for example), the control agent 31 periodically examines the suitability of the user's current social context.

According to one embodiment, the knowledge of the social context is acquired dynamically by continually analyzing the user's interactions or deterministically using data to be periodically entered/edited by the user.

When the extension 3 to the browser 1 is installed, the user is asked to create an account, specified by a user login, with the central semantic unit 20. This account comprises a description of the user's social context. When this account is created, the user
defines a login designating that account with the central semantic unit 20; and
enters the data of his or her social context (the virtual communities with which he or she is registered (for example forms, blogs, discussion groups, question/answer services, social networks, or collaborative remote work platforms) and the information needed to access them (address, login, password, proxy, session, or port, for example).

The user's social context is stored within the central semantic unit's 20 database 22.

According to one embodiment, when the browser 1 is launched, the control agent 31 asks the user to enter a login corresponding to an account already created with the central semantic unit 20. This makes it possible to preserve the privacy of multiple users who use the same terminal.

According to another embodiment, the public data (for example, social networks that the user is registered with, as well as the corresponding logins) is stored locally on the user's terminal, while the user's detailed social context (for example, the social networks, logins, passwords, descriptive statistics, and user contacts within each social network) is stored within the central semantic unit's 20 database 22. This information is transmitted by the control agent 31 to the central semantic unit 20 in order to be stored within the database 22 in a manner that preserves the privacy of their respective owners.

When browsing the page 2, the extraction means 30 to make it possible to distinguish the relevant text elements contained within that page.

According to one embodiment, the extraction of these terms is performed by means of named entity extraction means (Nadeau D. et al, “A survey of named entity recognition and classification”, Linguisticae Investigationes, January 2007). This technique makes it possible to avoid a less significant atomic analysis of the text content of the page 2.

Advantageously, the means for extracting 32 relevant terms, based on the extraction of named entities (also known as entity extraction) beginning on the page 2 being explored by the user, enable a better understanding of the content of the page 2 than by using, for example, extraction means based on keywords.

To give non-exhaustive examples, named entity extraction makes it possible to identify within the page 2 being explored by the user
proper names such as names (names of people, products, companies, hotels, countries, agencies, for example) or titles (titles of songs, artworks, movies, books, newspapers, magazines, for example);
acronyms;
time expressions (dates, event dates, or any other time designation);
numerical expressions (measurable values, quantities, percentages, comparisons, for example).
passages deemed to be relevant based on statistical indicators (number of repetitions within the page, for example);
important passages (title, summary, a phrase containing part of the title); and
multilingual terminology.

According to one embodiment, the means for extracting 32 relevant terms take into account the user's social context (the user is a member of a community that is passionate about a certain product, a certain brand, fans of an artist, a city, or team, for example).

It is clear to the person skilled in the art that other techniques, based on statistical or linguistic approaches, may also be used to extract information within a text context (Nadeau D. et al, “A survey of named entity recognition and classification”. Linguisticae Investigationes, January 2007). If so, the control agent 31 makes it possible to configure the extraction means 32.

By way of example, statistical indicators based on the frequency the terms appear within the page 2 and the frequency of the words in general language (to assign more or less weight to recurring terms) makes it possible to select the terms that are most descriptive of the text content of the page 2.

Following the extraction of the terms deemed relevant, depending on the user's social context, the control agent 31 requests information centered around these terms from the central semantic unit 20, which capitalizes on the content of the social networks 12, 13, 14.

Suppose that the user is a member of, or has previously explored, the two social networks 12, 13 (for example, www.facebook.com and a discussion group on http://qroups.google.fr).

The request transmitted by the control agent 31 to the central semantic unit 20 comprises the list of terms extracted from the page being explored by the user, as well as the user's login for the central semantic unit 20.

In order to be able to reply to this request, the central semantic unit 20 is equipped with three units:
polling means 21 that make it possible to semantically synthesize the content of the social networks 12, 13, 14;
a database 22 storing, in addition to the users' social networks, semantic information extracted from the social network 12, 13, 14. It capitalizes on the content of the social networks 12, 13, 14;
a querying interface 23 responsible for managing the interactions between the extension 3 to the browser 1 and the database 22.

The polling means 21 perform advanced processing on the content of the social networks 12, 13, 14, in order to synthesize a clear and concise piece of information from the opinions and comments that exist within the social networks 12, 13, 14. The polling means 21 than perform different types of semantic and/or statistical analyses (opinions, sentiments, statistical measurements) regarding the opinions, or more generally, the raw information found within the social networks 12, 13, 14.

The polling means 21 perform an analysis of the opinions (also known as opinion mining) posted within the social networks 12, 13, 14.

According to one embodiment, the polling means 21 analyze the options posted within community networks using named entity extraction means (Nadeau D. et al, “A survey of named entity recognition and classification”, Linguisticae Investigationes, January 2007). The result is a semantic synthesis of opinions regarding named entities, for example, artworks, public figures, books, commercial products, brands, or vacation destinations.

Different operating modes of the polling means 21 are described in “Dave D. et al, “Mining the Peanut Gallery: Opinion Extraction and semantic classification of product reviews”, proceedings of International World Wide Web conference, 2003”, and in “Hu M. et al, “Mining and summarizing customer reviews”, Proceedings of ACM SIGKDD International conference on knowledge discovery and data mining, 2004”.

By way of example, given the comment “I have owned this product “A” for 2 years, and I find that it is effective,” posted by a user “X” on the social network “S”, the semantic analysis of that comment by the polling means 21 concludes that this opinion, posted by the user “X” on the social network “S” and concerning the product “A” is positive. The polling means thereby reformulate this opinion, for example, with the help of a short graphical representation of emotion (emoticon) displaying a smile, a color code (green, for example), or a short phrase (“A” means effective, for example).

The semantic synthesis, by the polling means 21, of a comment or opinion is stored within the database 22 of extracted semantic information, and it is identifiable, for example, by
one or more details of its author's profile (group, user name), e-mail address, age, sex, telephone number, country, photo, for example);
the comment's named entity (the product “P”, the personality “A”, the film “F”, the process “R”, the date “T” for example);
the source social network 12, 13 or 14;
the date of publication;
the number of user interactions that cover that comment;
the number of semantic syntheses that are similar to it.

The content of the database 22 of semantic information extracted from the social networks 12, 13, 14 is regularly updated with the help of the semantic polling means 21.

According to one embodiment, the analysis frequency of a social network's content, by the polling means 21, depends on its content's variability rate over time.

The content of the database 22 of semantic information extracted from the social networks is classified so that the origin of any element of its content can easily be found. By way of example, its content may be classified by social network, by group, by author, by discussion topic, by date of publication, by file format, by named entity, or by subject.

It should be noted that the response provided by the central semantic unit to a request transmitted by the extension 3 to the browser 1 depends on the user's social context, the details of which are already stored in the database 22 and a public summary is included within the request.

The database 22 of semantic information extracted from the social networks has fast read access, in order to allow multiple users to query that base simultaneously.

The query interface 23 queries the database 22 of semantic information extracted from the social networks for every term transmitted from the extension 3 to the browser 1. These requests will deal with the semantic information extracted from the social networks 12, 13 of the user who is currently browsing the page 2, taking into account the user's social context. The effect of the responses to these requests is to respectively enrich the terms transmitted from the extension 3 to the browser 1.

The query interface 23 enables communication with different communication platforms (for example, video-on-demand. WEB, or WAP platforms), based on the corresponding access protocols (for example, http, https, ftp) or signalling protocols (for example, SIP, XMPP).

According to one embodiment, whenever there is a response to a request concerning a single term transmitted from the extension 3 to the browser 1, a single response may be selected, based on, for example,
the number of times these responses appear within the social networks;
the details of these responses (source social network of the response: specialized or general discussion group, publication date, author: family, friends, or colleagues, for example);
the user's social context (the social network most visited by the user or the social network comprising the most interactions by that user, for example).

According to one embodiment, whenever there is more than one response to a request concerning a single term transmitted from the extension 3 to the browser 1, all these responses are sent to the user.

The query interface 23 forwards the responses, obtained from the database 22, to the requests dealing with the relevant terms extracted by the extraction means 32 from the page 2 being explored by the user, to the extension 3 to the browser 1. These responses may be temporarily stored on the user's terminal.

The control agent 31 is tasked with managing the display of the information received from the central semantic database 20 and concerning the relevant terms extracted with the help of the extraction means 32 from the page 2 being explored by the user. Different modes for displaying this information are possible:
integrating the enriching information into the page 2 near their respective extracted terms;
displaying the relevant terms and their respective enriching within a new window, or in a new browser 1 tab;
highlighting (for example, underlining, coloring, or boxing) each relevant term extracted, from which non-blank content has been received from the central semantic unit 20, then, displaying within an infobubble the respective enriching information when the cursor is moved over that term.

The display medium of a piece of enriching information received from the central semantic unit 20, whether it is an infobubble or a window, offers different user interactions. These interactions concern, for example,
the author of hat information: call, send an e-mail/text, write to that author on the social network, see that author's profile;
the source social network: connecting to that social network, opening the source website (forum, blog),
the characteristics of that information: publication date, number of pieces of information identified within the social networks dealing with the current relevant theme;
offers to the user: beginning an interaction about that term with a contact (such as send this object to a friend, offer a gift to a friend, invite a friend to interact about this object).

The display medium showing a piece of enriching information automatically adapts to the format of that information:
a curve showing, for example, the borrowing of that book over time, the satisfaction of the user's contacts concerning a product; or
a piece of multimedia content displaying, for example, a trailer or clips from a movie (from the social networks Youtube® or Dailymotion®, for example), photos of the hotel, the road to access an airport, or a book's cover page.

It should be noted that the central semantic unit 20 may, for example be the responsibility of
an Internet service provider; or
any other entity managing a network. By way of example, a university's library may enrich the web browsing of its book-borrowing intranet site with the help of interactions within local social networks (students, teachers, classes, staff),

It should be noted that the extension 3 takes into consideration the parameters of the browser 1 used by the user,

The enrichment of user browsing obtained in this way from the user's community browsing makes it possible to give the user the benefit of the experiences of his or her social networks' members,

This enrichment represents a source of support for the user's browsing, by capitalizing on the trust that prevails between the members of an online community (the opinion of a known person is generally more influential than an anonymous opinion). It thereby improves the efficiency of current online searching practices.

1. A method for enriching the content of the page (2) placed online within a communication platform, and which can be consulted by a user with the help of a browser (1), said user being registered with at least one social network (12, 13, 14), wherein it comprises:
extracting relevant terms from the page (2) being explored by the user;
semantically synthesizing the content of a plurality of social networks that comprises at least one social network with which the user is registered;
retrieving information about the relevant terms extracted from the semantic synthesis of the content of the social networks with which the user is registered;
displaying the retrieved information to the user.

2. A method according to claim 1, wherein extracting the relevant terms extracts the named entities from the page (2) being explored by the user.

3. A method according to claim 1, wherein semantic synthesis analyzes the opinions posted within the social networks by using named entity extraction means.

4. A method according to claim 1, wherein semantic synthesis capitalizes, within a database (22), on the content of a plurality of social networks.

5. A method according to claim 1, wherein the database (22) is regularly updated.

6. A method according to claim 1, wherein the retrieved information depends on the user's social context.

7. A method according to claim 1, wherein the user's social context comprises the list of social networks with which he or she is registered, and the information needed to access them.

8. A method according to claim 1, wherein the data from the user's social context is collected dynamically.

9. A method according to claim 1, wherein displaying comprises:
the highlighting of each relevant term extracted;
the displaying within an infobubble of the retrieved information that corresponds to it when the cursor is moved over that term.

10. A device to assist the browsing of a user registered with at least one social network (12, 13, 14) who is also exploring a page (2) placed online within a communication platform and which can be viewed with the help of a browser (1), which assistance device or assistant wherein it comprises:
an extension (3) to the browser (1);
a central semantic unit (20) capitalizing on the content of a plurality of social networks comprising at least one social network with which the user is registered.

11. A user browsing assistant according to claim 10, wherein the extension (3) comprises:
means of extracting (32) relevant terms from the page (2) being explored by the user;
a control agent (31).

12. A user browsing assistant according to claim 10, wherein the extraction means (32) extract the named entities from the page (2) being explored by the user.

13. A user browsing assistant according to claim 10, wherein the central semantic processing unit (20) comprises
polling means (21) that make it possible to semantically synthesize the content of the social networks (12), (13), (14);
a database (22) storing the semantic information extracted from the social networks (12, 13, 14);
a querying interface (23) responsible for managing the interactions between the extension (3) to the browser (1) and the database (22).

14. A user browsing assistant according to claim 10, wherein the sorting means (21) analyze the opinions posted within the social networks using named entity extraction means.

15. A user browsing assistant according to claim 13, wherein the query interface (23) enables communication with different communication platforms based on the corresponding access or signaling protocols.

16. A computer program product implemented on a memory medium, which may be implemented within an information processing unit, and which comprises instructions for implementing a method according to claim 1.
